(19) United States
(12) Patent Application Publication
(10) Pub. No.: US 2016/0093249 A1
(43) Pub. Date: Mar. 31, 2016

(54) Scanning Structure and Bi-Directional Scanning Method for Driving a Pixel Circuit of an Active-Matrix Organic Light-Emitting Diode

(71) Applicant: EverDisplay Optronics (Shanghai) Limited, Shanghai (CN)

(72) Inventor: XingYu Zhou, Shanghai (CN)

(73) Assignee: EverDisplay Optronics (Shanghai) Limited

(21) Appl. No.: 14/600,285

(22) Filed: Jan. 20, 2015

(30) Foreign Application Priority Data
Sep. 30, 2014 (CN) 201410521858.2

(51) Int. Cl. G09G 3/32

(52) U.S. Cl. CPC G09G 3/3233

(57) ABSTRACT

A scanning structure for driving a pixel circuit of an active-matrix organic light-emitting diode display includes a Sn−1 signal unit having a pixel driving circuit for receiving an upper scan signal with a downward scanning direction and a lower scan signal with an upward scanning direction as an input signal. The pixel driving circuit includes a first input end and a first output end. A driving signal can be received by the first input end, transformed to a first scan signal by the pixel driving circuit, and outputted by the first output end. A Sn signal unit includes a Sn pixel circuit having a second input end coupled to the first output end and a second output end. The first scan signal can be received by the Sn pixel circuit and transformed to a second scan signal, and the second scan signal can be outputted by the second output end.

### BACKGROUND OF THE INVENTION

The present invention relates to a scanning structure and a bi-directional scanning method for driving a pixel circuit of an active-matrix organic light-emitting diode and, more particularly, to a scanning structure and a bi-directional scanning method for a display of an active-matrix organic light-emitting diode.

Currently, the scanning structure for active-matrix organic light-emitting diodes scans in a single direction. Nevertheless, liquid crystal displays use positive scan and reverse scan to provide a bi-directional scan in both of the positive and reverse directions. Thus, a need exists for achieving positive and reverse scans on the displays of active-matrix organic light-emitting diodes to increase the competitiveness of the active-matrix organic light-emitting diodes.

### BRIEF SUMMARY OF THE INVENTION

The present invention provides a bi-directional scanning structure that can be applied on active-matrix organic light-emitting diodes to increase the competitiveness of the active-matrix organic light-emitting diodes.

In a first aspect, a scanning structure for driving a pixel circuit of an active-matrix organic light-emitting diode display includes:

a Sn−1 signal unit including a pixel driving circuit, adapted to receive an upper scan signal with a downward scanning direction and a lower scan signal with an upward scanning direction as an input signal of the pixel driving circuit, wherein the pixel driving circuit includes a first input end and a first output end, such that a driving signal is able to be received by the first input end, transformed to a first scan signal by the pixel driving circuit, and outputted by the first output end; and

a Sn signal unit including a Sn pixel circuit, and the Sn pixel circuit including a second input end and a second output end, wherein the second input end is coupled to the first output end of the pixel driving circuit, such that the first scan signal is able to be received by the Sn pixel circuit and transformed to a second scan signal, and the second scan signal is able to be outputted by the second output.

The second scan signal and the first scan signal can have the same scanning direction.

The n of each of the Sn−1 signal unit and the Sn signal unit is a positive integer.

The scanning structure for driving a pixel circuit of an active-matrix organic light-emitting diode can further include a Sn+1 signal unit including a Sn+1 pixel circuit, and the Sn+1 pixel circuit can include a third input end and a third output end. The third input end is coupled to the second output end of the Sn pixel circuit, such that the second scan signal is able to be received by the Sn+1 pixel circuit to control the Sn+1 pixel circuit.

A scanning direction of the second scan signal is in accordance with that of the first scan signal, such that scanning directions of the Sn+1 signal unit and the Sn signal unit are in accordance with that provided by Sn−1 signal unit.

The n of each of the Sn−1 signal unit, the Sn signal unit, and the Sn+1 signal unit is a positive integer.

In a second aspect, a scanning structure for driving a pixel circuit of an active-matrix organic light-emitting diode includes:

a Sn−1 signal unit including a pixel driving circuit, adapted to receive an upper scan signal with a downward scanning direction and a lower scan signal with an upward scanning direction as an input signal of the pixel driving circuit, wherein the pixel driving circuit includes a first input end and a first output end, such that a driving signal is able to be received by the first input end, transformed to a first scan signal by the pixel driving circuit, and outputted by the first output end;

a Sn signal unit including a Sn pixel circuit, and the Sn pixel circuit including a second input end and a second output end, wherein the second input end is coupled to the first output end of the pixel driving circuit, such that the first scan signal is able to be received by the Sn pixel circuit and transformed to a second scan signal, and the second scan signal is able to be outputted by the second output, and wherein the Sn pixel circuit is controlled by the first scan signal; and

a Sn+1 signal unit including a Sn+1 pixel circuit, and the Sn+1 pixel circuit including a third input end and a third output end, wherein the third input end is coupled to the second output end of the Sn pixel circuit, such that the second scan signal is able to be received by the Sn+1 pixel circuit to control the Sn+1 pixel circuit.

A scanning direction of the second scan signal is in accordance with that of the first scan signal, such that scanning directions of the Sn+1 signal unit and the Sn signal unit are in accordance with that provided by Sn−1 signal unit.

The n of each of the Sn−1 signal unit, the Sn signal unit 2, and the Sn+1 signal unit is a positive integer.

In a third aspect, a method of bi-directional scanning is provided to drive a pixel circuit of an active-matrix organic light-emitting diode. The method is adapted to be used with a Sn−1 signal unit having a pixel driving circuit and a Sn signal unit having a Sn pixel circuit. The method includes:

providing an input signal to the pixel driving circuit of the Sn−1 signal unit, wherein the input signal comprises an upper scan signal with a downward scanning direction and a lower scan signal with an upward scanning direction;

providing a driving signal to the pixel driving circuit of the Sn−1 signal unit, and converting the driving signal to output a first scan signal; and

providing the first scan signal to the Sn pixel circuit of the Sn signal unit, and converting the first scan signal to output a second scan signal.

The input signal can be received by a first input end of the pixel driving circuit.

The first scan signal can be outputted by a first output end of the pixel driving circuit and received by a second input end of the Sn pixel circuit.

The second scan signal can be outputted by a second output end of the Sn pixel circuit.

Since the scanning structure for driving a pixel circuit of an active-matrix organic light-emitting diode is bi-directional, the competitiveness of the active-matrix organic light-emitting diode can greatly be increased.

The present invention will become clearer in light of the following detailed description of illustrative embodiments of this invention described in connection with the drawings.

### DESCRIPTION OF THE DRAWINGS

FIG. 1 is a diagrammatic view of a scanning structure for driving a pixel circuit of an active-matrix organic light-emitting diode of an embodiment according to the present invention.

FIG. 2 is a timing diagram of an upper scan signal of the scanning structure for driving a pixel circuit of an active-matrix organic light-emitting diode according to the present invention.

FIG. 3 is a timing diagram of a lower scan signal of the scanning structure for driving a pixel circuit of an active-matrix organic light-emitting diode according to the present invention.

FIG. 4 is a simulation of the timing program of the upper scan signal of the scanning structure for driving a pixel circuit of an active-matrix organic light-emitting diode according to the present invention.

FIG. 5 is a simulation of the timing program of the lower scan signal of the scanning structure for driving a pixel circuit of an active-matrix organic light-emitting diode according to the present invention.

### REFERENCE NUMBERS

10 Sn−1 signal unit
11 pixel driving circuit
12 first input
13 first output
20 Sn signal unit
21 Sn pixel circuit
22 second input
23 second output
30 Sn+1 signal unit
31 Sn+1 pixel circuit
32 third input
33 third output
01 upper scanning signal
02 lower scanning signal
03 driving signal
04 first scan signal
05 second scan signal

### DETAILED DESCRIPTION OF THE INVENTION

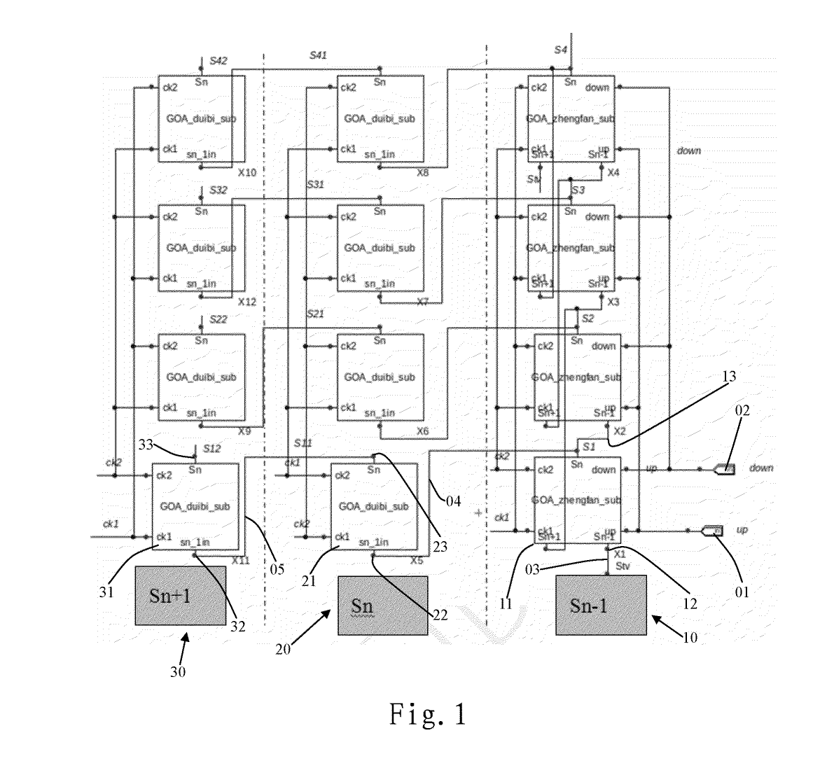

With reference to FIG. 1, a scanning structure for driving a pixel circuit of an active-matrix organic light-emitting diode of an embodiment according to the present invention can be used on a display of an active-matrix organic light-emitting diode. The scanning structure for driving a pixel circuit of an active-matrix organic light-emitting diode includes a Sn−1 signal unit 10, a Sn signal unit 20, and a Sn+1 signal unit 30 including at least one Sn+1 pixel circuit 31.

The Sn−1 signal unit 10 includes at least one pixel driving circuit 11. The at least one pixel driving circuit 11 can receive an upper scan signal 01 and a lower scan signal 02 as a signal input for the at least one pixel driving circuit 11. The upper scan signal 01 scans downwards. The lower scan signal 02 scans upwards. The at least one pixel driving circuit 11 includes a first input 12 and a first output 13. The first input 12 can receive a driving signal 03. The at least one pixel driving circuit 11 can convert the driving signal 03 into a first scan signal 04. The first scan signal 04 can be outputted via the first output 13.

The Sn signal unit 20 includes at least one Sn pixel circuit 21. The at least one Sn pixel circuit 21 includes a second input 22 and a second output 23. The second input 22 is coupled to the first output 13 of the at least one pixel driving circuit 11. Thus, the at least one Sn pixel circuit 21 can receive the first scan signal 04 and can be controlled by the first scan signal 04. The first scan signal 04 is converted by the at least one Sn pixel circuit 21 into a second scan signal 05. The second scan signal 05 can be outputted via the second output 23.

The Sn+1 signal unit 30 includes at least one Sn+1 pixel circuit 31. The at least one Sn+1 pixel circuit 31 includes a third input 32 and a third output 33. The third input 32 of the at least one Sn+1 pixel circuit 31 is coupled to the second output 23 of the at least one Sn pixel circuit 21. Thus, the at least one Sn+1 pixel circuit 31 can receive the second scan signal 05 and can be controlled by the second scan signal 05.

Conversion of the first scan signal 04 will cause conversion of the second scan signal 05. Thus, the second scan signal 05 scans in a scanning direction of the first scan signal 04. As a result, the Sn+1 signal unit 30 and the Sn signal unit 20 scan in a signal scanning direction provided by Sn−1 signal unit 10.

Note that n of each of the Sn−1 signal unit 10, the Sn signal unit 20, and the Sn+1 signal unit 30 is a positive integer.

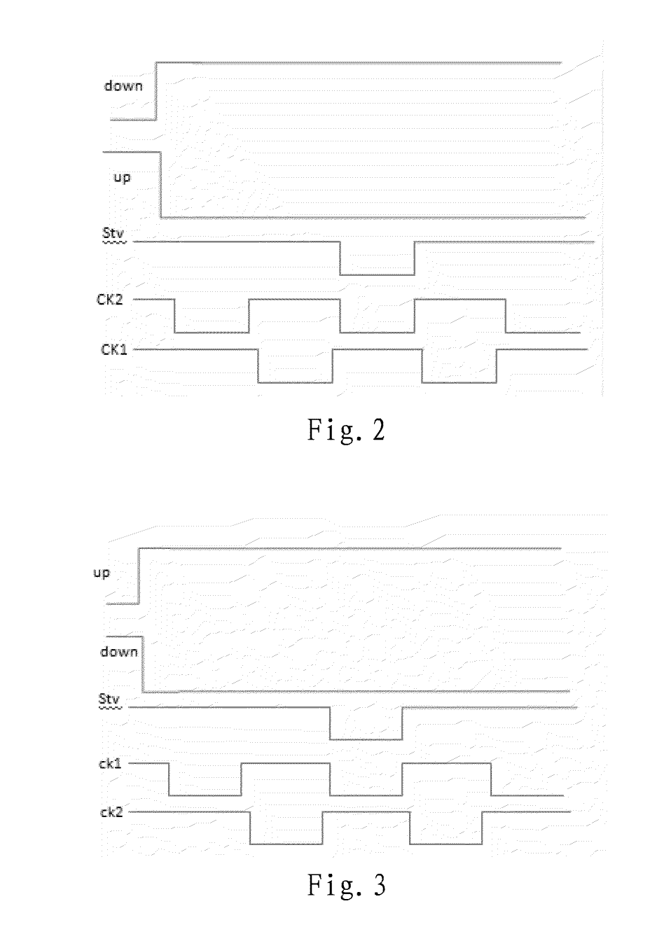

FIG. 2 is a timing diagram of the upper scan signal 01 of the scanning structure for driving a pixel circuit of an active-matrix organic light-emitting diode according to the present invention, wherein ck1 and ck2 represent the frequency control. The upper scan signal 01 generated is inputted to the at least one pixel driving circuit 11.

FIG. 3 is a timing diagram of the lower scan signal 02 of the scanning structure for driving a pixel circuit of an active-matrix organic light-emitting diode according to the present invention, wherein ck1 and ck2 represent the frequency control. The lower scan signal 02 generated is inputted to the at least one pixel driving circuit 11.

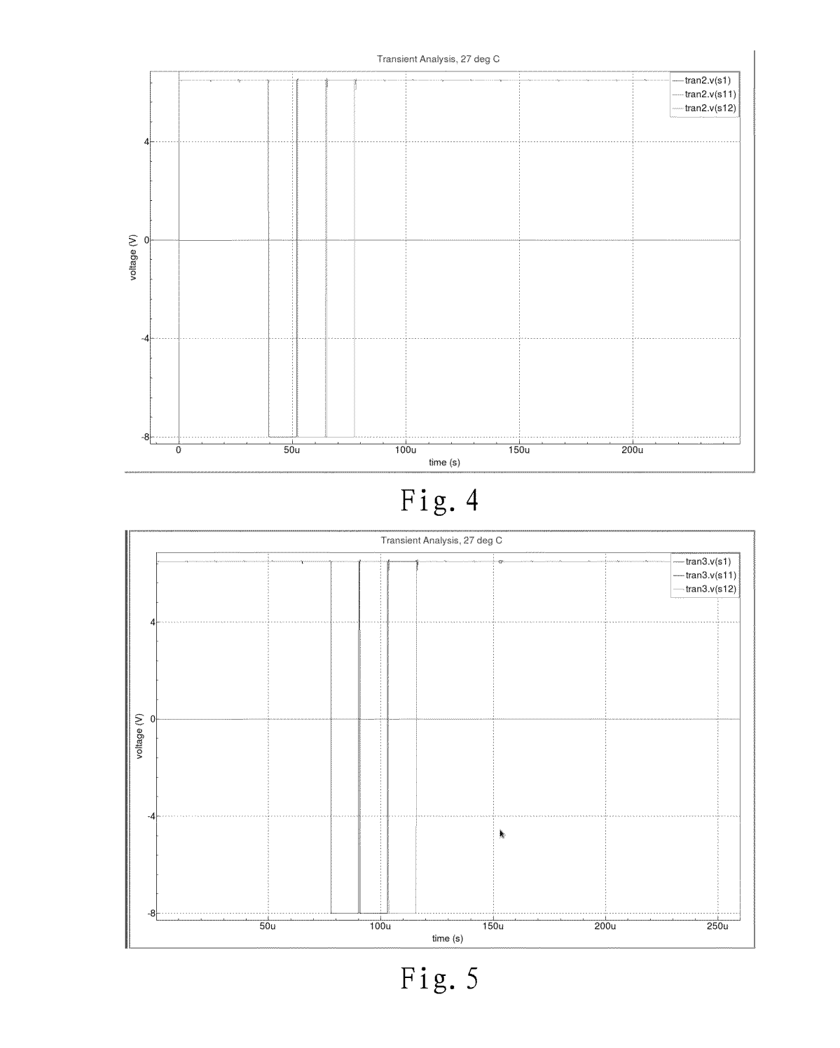

FIGS. 4 and 5 are simulations of the timing programs of the upper scan signal 01 and the lower scan signal 02 of the scanning structure for driving a pixel circuit of an active-matrix organic light-emitting diode according to the present invention. As can be seen from FIGS. 4 and 5, in both of the upper scan signal 01 and the lower scan signal 02, each signal generated follows the previous signal, assuring the timing sequences required by the same pixel driving circuit 11 are the same and, thus, assuring normal operation of the pixels.

Conclusively, a method of bi-directional scanning is provided to drive a pixel circuit of an active-matrix organic light-emitting diode. The method is adapted to be used with a Sn−1 signal unit 10 having a pixel driving circuit 11 and a Sn signal unit 20 having a Sn pixel circuit 21. The method includes:

providing an input signal to the pixel driving circuit 11 of the Sn−1 signal unit 10, wherein the input signal comprises an upper scan signal 01 with a downward scanning direction and a lower scan signal 02 with an upward scanning direction;

providing a driving signal 03 to the pixel driving circuit 11 of the Sn−1 signal unit 10, and converting the driving signal 03 to output a first scan signal 04; and

providing the first scan signal 04 to the Sn pixel circuit 21 of the Sn signal unit 20, and converting the first scan signal 04 to output a second scan signal 05.

The input signal can be received by a first input end 12 of the pixel driving circuit 11.

The first scan signal 04 can be outputted by the first output end 13 of the pixel driving circuit 11 and received by a second input end 22 of the Sn pixel circuit 21.

The second scan signal 05 can be outputted by a second output end 23 of the Sn pixel circuit 21.

Although specific embodiments have been illustrated and described, numerous modifications and variations are still possible without departing from the scope of the invention. The scope of the invention is limited by the accompanying claims.

1. A scanning structure for driving a pixel circuit of an active-matrix organic light-emitting diode display, the scanning structure comprising:
a Sn−1 signal unit including a pixel driving circuit, adapted to receive an upper scan signal with a downward scanning direction and a lower scan signal with an upward scanning direction as an input signal of the pixel driving circuit, wherein the pixel driving circuit includes a first input end and a first output end, such that a driving signal is able to be received by the first input end, transformed to a first scan signal by the pixel driving circuit, and outputted by the first output end; and
a Sn signal unit including a Sn pixel circuit, and the Sn pixel circuit including a second input end and a second output end, wherein the second input end is coupled to the first output end of the pixel driving circuit, such that the first scan signal is able to be received by the Sn pixel circuit and transformed to a second scan signal, and the second scan signal is able to be outputted by the second output.

2. The scanning structure according to claim 1, wherein the second scan signal and the first scan signal have the same scanning direction.

3. The scanning structure according to claim 1, wherein n of each of the Sn−1 signal unit and the Sn signal unit is a positive integer.

4. The scanning structure according to claim 1, further comprising: a Sn+1 signal unit including a Sn+1 pixel circuit, and the Sn+1 pixel circuit including a third input end and a third output end, wherein the third input end is coupled to the second output end of the Sn pixel circuit, such that the second scan signal is able to be received by the Sn+1 pixel circuit to control the Sn+1 pixel circuit.

5. The scanning structure according to claim 4, wherein a scanning direction of the second scan signal is in accordance with that of the first scan signal, such that scanning directions of the Sn+1 signal unit and the Sn signal unit are in accordance with that provided by Sn−1 signal unit.

6. The scanning structure according to claim 4, wherein n of each of the Sn−1 signal unit, the Sn signal unit, and the Sn+1 signal unit is a positive integer.

7. A scanning structure for driving a pixel circuit of an active-matrix organic light-emitting diode, comprising:
a Sn−1 signal unit including a pixel driving circuit, adapted to receive an upper scan signal with a downward scanning direction and a lower scan signal with an upward scanning direction as an input signal of the pixel driving circuit, wherein the pixel driving circuit includes a first input end and a first output end, such that a driving signal is able to be received by the first input end, transformed to a first scan signal by the pixel driving circuit, and outputted by the first output end;
a Sn signal unit including a Sn pixel circuit, and the Sn pixel circuit including a second input end and a second output end, wherein the second input end is coupled to the first output end of the pixel driving circuit, such that the first scan signal is able to be received by the Sn pixel circuit and transformed to a second scan signal, and the second scan signal is able to be outputted by the second output, and wherein the Sn pixel circuit is controlled by the first scan signal; and
a Sn+1 signal unit including a Sn+1 pixel circuit, and the Sn+1 pixel circuit including a third input end and a third output end, wherein the third input end is coupled to the second output end of the Sn pixel circuit, such that the second scan signal is able to be received by the Sn+1 pixel circuit to control the Sn+1 pixel circuit.

8. The scanning structure according to claim 7, wherein a scanning direction of the second scan signal is in accordance with that of the first scan signal, such that scanning directions of the Sn+1 signal unit and the Sn signal unit are in accordance with that provided by Sn−1 signal unit.

9. The scanning structure according to claim 7, wherein n of each of the Sn−1 signal unit, the Sn signal unit 2, and the Sn+1 signal unit is a positive integer.

10. A method of bi-directional scanning to drive a pixel circuit of an active-matrix organic light-emitting diode, the method adapted to be used with a Sn−1 signal unit having a pixel driving circuit and a Sn signal unit having a Sn pixel circuit, the method comprising:
providing an input signal to the pixel driving circuit of the Sn−1 signal unit, wherein the input signal comprises an upper scan signal with a downward scanning direction and a lower scan signal with an upward scanning direction;
providing a driving signal to the pixel driving circuit of the Sn−1 signal unit, and converting the driving signal to output a first scan signal; and
providing the first scan signal to the Sn pixel circuit of the Sn signal unit, and converting the first scan signal to output a second scan signal.

11. The method according to claim 10, wherein the input signal is received by a first input end of the pixel driving circuit.

12. The method according to claim 11, wherein the first scan signal is outputted by a first output end of the pixel driving circuit and received by a second input end of the Sn pixel circuit.

13. The method according to claim 12, wherein the second scan signal is outputted by a second output end of the Sn pixel circuit.
